(19) United States
(12) Patent Application Publication
(10) Pub. No.: US 2019/0262945 A1
(43) Pub. Date: Aug. 29, 2019

(54) PROCESS FOR MANUFACTURING A TURBOMACHINE BLADE

(71) Applicant: SAFRAN HELICOPTER ENGINES, Bordes (FR)

(72) Inventors: Yann DANIS, Moissy-Cramayel (FR); Denis Daniel Jean BOISSELEAU, Moissy-Cramayel (FR)

(73) Assignee: SAFRAN HELICOPTER ENGINES, Bordes (FR)

(21) Appl. No.: 16/348,341

(22) PCT Filed: Nov. 10, 2017
(86) PCT No.: PCT/FR2017/053070

§ 371 Date: May 8, 2019

(30) Foreign Application Priority Data
Nov. 10, 2016 (FR) 1660907

(51) Int. Cl. B23K 26/342; F01D 5/18; F01D 5/28; F01D 9/04; B33Y 10/00; B33Y 80/00; B33Y 70/00; C22C 9/06; B23K 26/00; B23K 26/082

(52) U.S. Cl. CPC B23K 26/342; F01D 5/186; F01D 5/28; F01D 9/041; B33Y 10/00; B23K 2101/001; B33Y 70/00; C22C 9/06; B23K 26/0006; B23K 26/082; B33Y 80/00

(57) ABSTRACT

A process for manufacturing a turbomachine blade of the type having at least one 3D cavity, wherein the blade is produced by a succession of depositions and selective consolidations of layers of a metal additive manufacturing powder based on an alloy of copper and nickel, the alloy including from 2% to 7% of nickel. It also relates to a turbomachine blade, wherein it is manufactured by metal additive manufacturing using the process.

The present invention relates to the manufacture of turbomachine vanes and more particularly to the manufacture of vanes of complex internal shape, and this more particularly when these vanes are also of complex external shapes.

It finds in particular advantageous application in the case of variable-pitch compressor vanes of the type including internal cavities.

### GENERAL TECHNICAL FIELD AND PRIOR ART

Many turbomachine vanes, and in particular some variable-pitch vanes of a compressor distributor (called IGV “Inlet Guide Vane”), can have complex 3D shapes preventing them from being manufactured in one piece.

This is in particular the case of IGV vanes in which internal cavities are provided for the circulation of air.

A conventional technique for manufacturing such vanes consists in manufacturing by forging the various parts intended to constitute the complete shape (the main vane body, a cover and the cap at the vane tail), to machine bearing surfaces and to assemble them by induction brazing.

This implementation is complex and becomes all the more impossible in case of combination with complex external shapes as well.

However, it is further hardly compatible with an industrial operation, especially in terms of tolerances and costs.

Foundry processes, also complex, do not constitute possible solutions, in particular given the cloth thicknesses of the vanes.

Metal injection molding (or MIM) techniques would involve, for their part, the injection of several parts and a brazing during the sintering. Their use would be even more complicated than the use of forging solutions.

Additive manufacturing techniques are in addition conventionally used today in many fields.

However, to date, the solutions proposed by the manufacturers of additive manufacturing machines are not compatible with the mechanical and thermal characteristics expected for the turbomachine vanes.

### GENERAL PRESENTATION OF THE INVENTION

An object of the invention is to propose a manufacturing method for turbomachine vanes of complex internal shape.

Another object of the invention is to propose a manufacturing method that is simple to implement and compatible with the costs and tolerance levels expected in the case of industrial operation.

Yet another object of the invention is to propose a method that allows the manufacture of vanes that have good thermal conductivity and good resistance to abrasion.

In particular, the invention proposes a method for manufacturing a turbomachine vane of the type having at least one 3D cavity, characterized in that said vane is produced by a succession of deposits and selective consolidations of layers of a metal additive manufacturing powder based on an alloy of copper and nickel, said alloy including from 2 to 7% of nickel, preferably from 2 to 5% and even more preferably in the order of 3%.

The invention also relates to a turbomachine vane manufactured in this way, said vane being made of copper and nickel alloy based-material, said alloy including from 2 to 7% of nickel (preferably from 2 to 5% and even more preferably in the order of 3%), which gives it the desired mechanical and thermal properties.

The invention is advantageously applicable in the case of variable-pitch vane of a turbomachine compressor distributor, including at least one air circulation cavity.

### PRESENTATION OF THE FIGURES

Other characteristics and advantages of the invention will become apparent from the following description, which is purely illustrative and not limiting, and should be read with reference to the single appended FIGURE on which a turbomachine compressor vane is schematically represented.

### DESCRIPTION OF ONE OR SEVERAL MODE(S) OF IMPLEMENTATION AND EMBODIMENT(S)

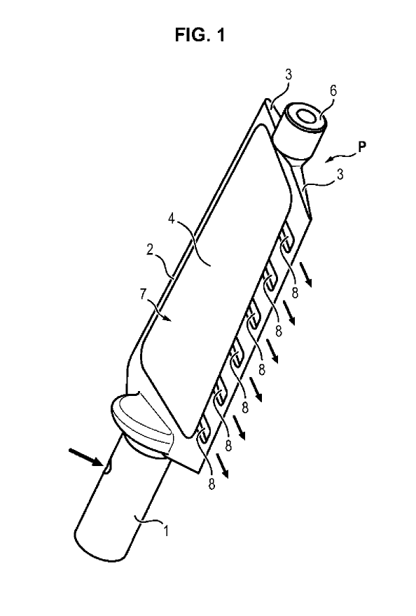

The vane V of FIG. 1 is a variable-pitch vane of a turbomachine compressor distributor.

It extends from a root 1 and has a leading edge 2, a trailing edge 3, in connection with an extrados 4 and an intrados 5. At its end opposite to the root 1, the vane V ends with a cylindrical plate 6 for the articulated attachment of said vane V on a compressor casing.

A cavity 7 extends inside the vane, in the length thereof. This cavity 7 is intended to allow air circulation.

The root 1 has for this purpose one or more orifice(s) 8 used as air inlet.

The trailing edge 3 has, for its part, a plurality of openings 8 forming an air outlet. These openings 8 have shapes that optimize their aeronautical behavior (which contributes to complicating the shape of the part).

Such a vane has for example a length of 10 cm and a web width in the order of 4 cm.

The part it constitutes is manufactured in a single step, by additive manufacturing on a metal powder bed.

For this purpose, additive manufacturing machines using EBM (Electron Beam Melting) technology or additive manufacturing by Selective Laser Melting (SLM) technology are used.

Other technologies of metal additive manufacturing are also possible (machines combining the two technologies for example).

The manufacturing powder is based on an alloy of copper and nickel which includes from 2 to 7% of nickel, preferably from 2 to 5% and particularly more preferably in the order of 3%.

The copper alloy family with 2 to 7% of nickel is the one with the best compromise between high thermal conductivity and good resistance to erosion. For the application to IGV vanes in which internal cavities are provided for air circulation, good thermal conductivity is needed, for example to allow efficient defrosting, as well as good resistance to erosion since its vanes are located at the engine inlet and can therefore undergo erosion by sand for example.

The layers of powder are successively deposited and consolidated in order to build the vane layer by layer.

Preferred manufacturing parameters are given below in the case of additive manufacturing by laser melting:

Power of the laser: between 100 and 500 W, and more preferably between 300 and 400 W;

Scanning speed of the laser beam on the powder layers: between 300 and 2000 mm/s, and more preferably between 700 and 1000 mm/s;

Gap between the lines along which the laser beam moves: between 0.005 mm and 0.02 mm, and more preferably between 0.007 mm and 0.015 mm;

Thickness of the powder layers: between 20 and 40 μm;

Particle size D50 of the powder: in the order of 35 μm.

After manufacture, the vane thus produced is detached from the support plate of the machine.

After suction of the remaining powder, the vane may be subject to a finishing treatment (polishing, or even re-machining of some surfaces).

It may also be subject to complementary heat treatments (aging treatment at temperatures comprised between 350° C. and 620° C., for example).

Note that the vanes obtained—made of copper and nickel alloy based-material, said alloy including from 2 to 7% of nickel—are particularly satisfactory in terms of thermal and mechanical properties: the alloy is highly conductive and has a high resistance to abrasion.

The proposed method is therefore particularly suitable in the case of a vane with air circulation cavity.

In the absence of brazing, it is simple and inexpensive. It further allows tolerances compatible with those expected in the aviation industry.

1. A method for manufacturing a turbomachine vane of the type having at least one 3D cavity, wherein said vane is produced by a succession of deposits and selective consolidations of layers of a metal additive manufacturing powder based on an alloy of copper and nickel, said alloy including from 2 to 7% of nickel.

2. The method according to claim 1, wherein an additive manufacturing by EBM technology is implemented.

3. The method according to claim 1, wherein an additive manufacturing by laser melting is implemented.

4. The method according to claim 3, wherein the laser power is comprised between 100 and 500 W.

5. The method according to claim 3, wherein the scanning speed of the laser beam on the powder layers is comprised between 300 and 2000 mm/s.

6. The method according to claim 3, wherein the gap between the lines along which the laser beam moves is comprised between 0.005 mm and 0.02 mm.

7. The method according to claim 3, wherein the thickness of the powder layers is comprised between 20 and 40 μm.

8. The method according to claim 3, wherein the particle size D50 of the powder is in the order of 35 μm.

9. A turbomachine vane, wherein it is manufactured by metal additive manufacturing by implementing a method according to claim 1, said vane being made of copper and nickel alloy based-material, said alloy including 2 to 7% of nickel.

10. A variable-pitch vane of a turbomachine compressor distributor, comprising at least one air circulation cavity, wherein said vane is manufactured by metal additive manufacturing by implementing a method according to claim 1, said vane being made of copper and nickel alloy based-material, said alloy including from 2 to 7% of nickel.
